(19) United States
(12) Patent Application Publication
(10) Pub. No.: US 2011/0058201 A1
(43) Pub. Date: Mar. 10, 2011

(54) METHOD AND APPARATUS FOR IDENTIFYING PARTS IN AN IMAGE PRODUCTION DEVICE

(75) Inventor: David A. Mueller, Webster, NY (US)

(73) Assignee: XEROX CORPORATION, Norwalk, CT (US)

(21) Appl. No.: 12/555,075

(22) Filed: Sep. 8, 2009

(51) Int. Cl. G06F 15/00

(52) U.S. Cl. 358/1.13

(57) ABSTRACT

A method and apparatus for identifying parts in an image production device may include receiving a request to print a print job from a user, determining the print job specifications, detecting identification devices of parts that are installed in the image production device and extracting the corresponding part identification information, determining if the detected parts are the parts that have been identified for the determined print job specifications based on the extracted part identification information, wherein if one or more detected parts that are installed in the image production device are the parts that have been identified for the determined print job specifications, processing the print job, otherwise, notifying the user that the installed parts are not the parts that have been identified for the determined print job specifications, and prompting the user to elect to replace the installed parts, change the print job specifications, or proceed with the print job.

### BACKGROUND

Disclosed herein is a method for identifying parts in an image production device, as well as corresponding apparatus and computer-readable medium.

Interchangeable parts targeted for specific applications in an image production device can be used in the wrong application or conditions when an alternate part or tool should be used in the device. For example, in a xerographic application, users print with different width media that may result in an image quality defect in the fuser if the same fuser is used for each media width. As a result, users can be provided with multiple fusers (each designed for a different media width) that are customer replaceable units (CRUs). For example, one is targeted for small size media, and the other is for large size media, etc. However, conventional image production devices do not recognize the difference in fusers and will process print jobs using any installed fuser which may cause damage to the fuser.

### SUMMARY

A method and apparatus for identifying parts in an image production device is disclosed. The method may include receiving a request to print a print job from a user, determining the print job specifications, detecting identification devices of parts that are installed in the image production device and extracting the corresponding part identification information, determining if the detected parts that are installed in the image production device are the parts that have been identified for the determined print job specifications based on the extracted part identification information, wherein if it is determined that the detected parts that are installed in the image production device are the parts that have been identified for the determined print job specifications, processing the print job, otherwise, if it is determined that one or more detected parts that are installed in the image production device are not the parts that have been identified for the determined print job specifications, notifying the user using a user interface that the one or more installed parts are not the parts that have been identified for the determined print job specifications, and prompting the user using the user interface to elect to replace the one or more installed parts, change the print job specifications, or proceed with the print job.

### BRIEF DESCRIPTION OF THE DRAWINGS

FIG. 1 is an exemplary diagram of an image production device in accordance with one possible embodiment of the disclosure;

FIG. 2 is a exemplary block diagram of the image production device in accordance with one possible embodiment of the disclosure;

FIG. 3 is a flowchart of an exemplary part identification process in accordance with one possible embodiment of the disclosure;

FIG. 4 is a diagram of a fuser roll assembly having an exemplary identification device attached to a fuser roll in accordance with one possible embodiment of the disclosure; and

FIG. 5 is an exemplary identification device in accordance with one possible embodiment of the disclosure.

### DETAILED DESCRIPTION

Aspects of the embodiments disclosed herein relate to a method for identifying parts in an image production device, as well as corresponding apparatus and computer-readable medium.

The disclosed embodiments may include a method for identifying parts in an image production device. The method may include receiving a request to print a print job from a user, determining the print job specifications, detecting identification devices of parts that are installed in the image production device and extracting the corresponding part identification information, determining if the detected parts that are installed in the image production device are the parts that have been identified for the determined print job specifications based on the extracted part identification information, wherein if it is determined that the detected parts that are installed in the image production device are the parts that have been identified for the determined print job specifications, processing the print job, otherwise, if it is determined that one or more detected parts that are installed in the image production device are not the parts that have been identified for the determined print job specifications, notifying the user using a user interface that the one or more installed parts are not the parts that have been identified for the determined print job specifications, and prompting the user using the user interface to elect to replace the one or more installed parts, change the print job specifications, or proceed with the print job.

The disclosed embodiments may further include an image production device that may include a user interface for displaying information and receiving selects from a user, a part detector that detects identification devices of parts that are installed in the image production device and extracts the corresponding part identification information, and a part identification unit that receives a request to print a print job from a user, determines the print job specifications, receives the extracted part identification information from the identification devices detected by the part detector, determines if the detected parts that are installed in the image production device are the parts that have been identified for the determined print job specifications based on the extracted part identification information, wherein if the part identification unit determines that the detected parts that are installed in the image production device are the parts that have been identified for the determined print job specifications, the part identification unit processes the print job, otherwise, if the part identification unit determines that one or more detected parts that are installed in the image production device are not the parts that have been identified for the determined print job specifications, the part identification unit notifies the user using the user interface that the one or more installed parts are not the parts that have been identified for the determined print job specifications, and prompts the user using the user interface to elect to replace the one or more installed parts, change the print job specifications, or proceed with the print job.

The disclosed embodiments may further include a computer-readable medium storing instructions for controlling a computing device for identifying parts in an image production device. The instructions may include receiving a request to print a print job from a user, determining the print job specifications, detecting identification devices of parts that are installed in the image production device and extracting the corresponding part identification information, determining if the detected parts that are installed in the image production device are the parts that have been identified for the determined print job specifications based on the extracted part identification information, wherein if it is determined that the detected parts that are installed in the image production device are the parts that have been identified for the determined print job specifications, processing the print job, otherwise, if it is determined that one or more detected parts that are installed in the image production device are not the parts that have been identified for the determined print job specifications, notifying the user using a user interface that the one or more installed parts are not the parts that have been identified for the determined print job specifications, and prompting the user using the user interface to elect to replace the one or more installed parts, change the print job specifications, or proceed with the print job.

The disclosed embodiments concern a process that allows a user to interact with mechanical, electrical or consumable items through a user interface to identify parts installed on an image production device. For example, in certain instances, a user may wish to uniquely identify a part to be used only for specific applications based on the image production device's capability. When initially installed, the part and image production device interaction may default to no limitation but may initiate a user response screen or process where the user may select “accept default” or identify it based on specific input that the image production device can correlate to a feature function, such as paper size in the case of a xerographic machine.

Based on this input, the image production device may screen actions based on the specific input and limit operations to match the constraints of the user-defined characteristics. When a conflict is identified with the user-defined part, the image production device may prompt the operator to perform some type of action, including but not limited to replacing the part, overriding the conflict, or other appropriate action. The information may be stored on a memory tag, such as a customer replaceable unit monitor (CRUM) tag, an integrated circuit chip, or a radio frequency identification (RFID) tag, for example, that may attached to or integrated into the part or component being screened for conflicts.

Specific parts may be assembled with the memory tag or it may be installed or retrofitted later. When the part is installed into the image production device, the image production device may detect and read the memory tag. The user may be prompted to enter identification (ID) criteria based on characteristics of the part. This identification information may be stored on the memory tag and/or in the image production device memory for future conflict resolution characteristics. The ID may be used to inform the operator if the action requested violates the ID criteria. Multiple parameters may be entered, including media size, type, finishing, etc. For example, criteria in a printer application may include defined paper sizes or ranges such as 8 inch, 11 inch, 12 inch, and up to the maximum width of the image production device, paper weight, or any attribute that could be used for conflict detection.

As a further example, in fusing technology, fusers may have a sensitivity to wear failures based on paper width. In the xerographic fusing industry, it is common to have wear marks introduced into the fuser roll based on running a specific weight and sized media. If a subsequent print job is submitted that uses wider paper and imaged area that over laps the wear mark on the fuser roll, an image quality defect becomes visible is often objectionable to the user causing roll replacement prior to the expected time period. For example, a fuser that is intended only to run 11 in paper media may have an ID of 11. If the incoming job required paper media that has a width different then 11, such as 12 inch, the image production device may not print the job without user override. In this manner, the image production device may inform the operator of the mismatch allowing the operator to either continue printing with the current device or perform a part removal and replacement with a part that meets the criteria.

The value of this process may be that users running specific size paper can maximize life of the parts while maintaining good image quality and up time vs. waiting for service to repair or bring alternate parts. Current field strategies may allow multiple fusers to be kept on site for users to allow them to switch out a fuser intended for specific size media. The disclosed embodiments may provide an automatic process that may prevent unintended use of identified parts in the image production device, and may permit notification to the user when such a mismatch occurs.

The benefits of this process may include allowing components with different wear characteristics based on size or other differentiable metrics to have extended life or prevent unintentional damage thereto, reducing defect rate when switching components with difference life characteristics, and increasing user uptime when using multi-sized media or devices with variable life characteristics.

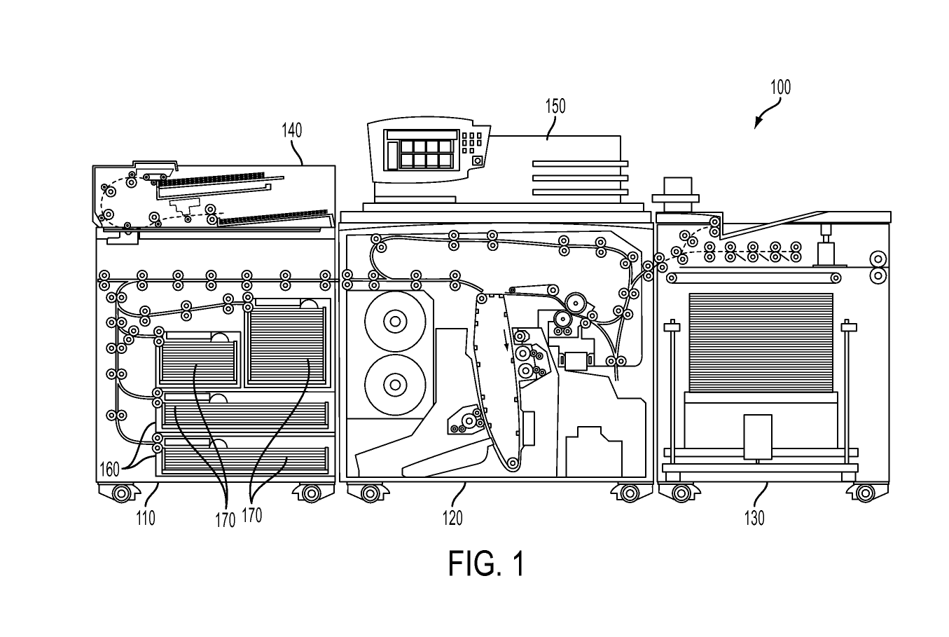

FIG. 1 is an exemplary diagram of an image production device 100 in accordance with one possible embodiment of the disclosure. The image production device 100 may be any device that may be capable of making image production documents (e.g., printed documents, copies, etc.) including a copier, a printer, a facsimile device, and a multi-function device (MFD), for example.

The image production device 100 may include an image production section 120, which includes hardware by which image signals are used to create a desired image, as well as a stand-alone feeder section 110, which stores and dispenses sheets on which images are to be printed, and an output section 130, which may include hardware for stacking, folding, stapling, binding, etc., prints which are output from the marking engine. If the image production device 100 is also operable as a copier, the image production device 100 may further includes a document feeder 140, which operates to convert signals from light reflected from original hard-copy image into digital signals, which are in turn processed to create copies with the image production section 120. The image production device 100 may also include a local user interface 150 for controlling its operations, although another source of image data and instructions may include any number of computers to which the printer is connected via a network.

With reference to feeder section 110, the section may include any number of trays 160, each of which stores a media stack 170 or print sheets (“media”) of a predetermined type (size, weight, color, coating, transparency, etc.) and may include a feeder to dispense one of the sheets therein as instructed. Certain types of media may require special handling in order to be dispensed properly. For example, heavier or larger media may desirably be drawn from a media stack 170 by use of an air knife, fluffer, vacuum grip or other application (not shown in the Figure) of air pressure toward the top sheet or sheets in a media stack 170. Certain types of coated media may be advantageously drawn from a media stack 170 by the use of an application of heat, such as by a stream of hot air (not shown in the Figure). Sheets of media drawn from a media stack 170 on a selected tray 160 may then be moved to the image production section 120 to receive one or more images thereon. Then, the printed sheet is then moved to output section 130, where it may be collated, stapled, folded, punched, etc., with other media sheets in manners familiar in the art.

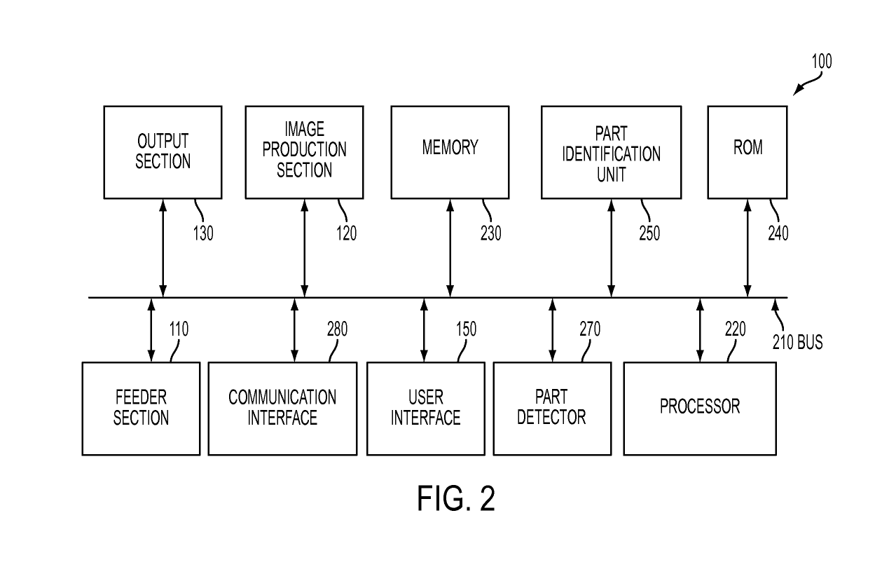

FIG. 2 is an exemplary block diagram of the image production device 100 in accordance with one possible embodiment of the disclosure. The image production device 100 may include a bus 210, a processor 220, a memory 230, a read only memory (ROM) 240, a part identification unit 250, a feeder section 110, an output section 130, a user interface 150, a communication interface 280, an image production section 120, and a part detector 270. Bus 210 may permit communication among the components of the image production device 100.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

User interface 150 may include one or more conventional mechanisms that permit a user to input information to and interact with the image production unit 100, such as a keyboard, a display, a mouse, a pen, a voice recognition device, touchpad, buttons, etc., for example. Output section 130 may include one or more conventional mechanisms that output image production documents to the user, including output trays, output paths, finishing section, etc., for example. The image production section 120 may include an image printing and/or copying section, a scanner, a fuser, etc., for example.

The part detector 270 may be any device that may be able to detect identification devices, such CRUM tags, RFID tags, or integrated chips, for example. The part detector 270 may be of a type that may be able to detect passive identification devices and/or receive signals from active identification devices known to one of skill in the art. Note that passive devices may include the use of fuse-able links or other mechanical adjustments that would allow the part detector 270 to differentiate between parts, for example.

The image production device 100 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The image production device 100 illustrated in FIGS. 1-2 and the related discussion are intended to provide a brief, general description of a suitable communication and processing environment in which the disclosure may be implemented. Although not required, the disclosure will be described, at least in part, in the general context of computer-executable instructions, such as program modules, being executed by the image production device 100, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like that are capable of displaying the print release marking and can be scanned by the image production device.

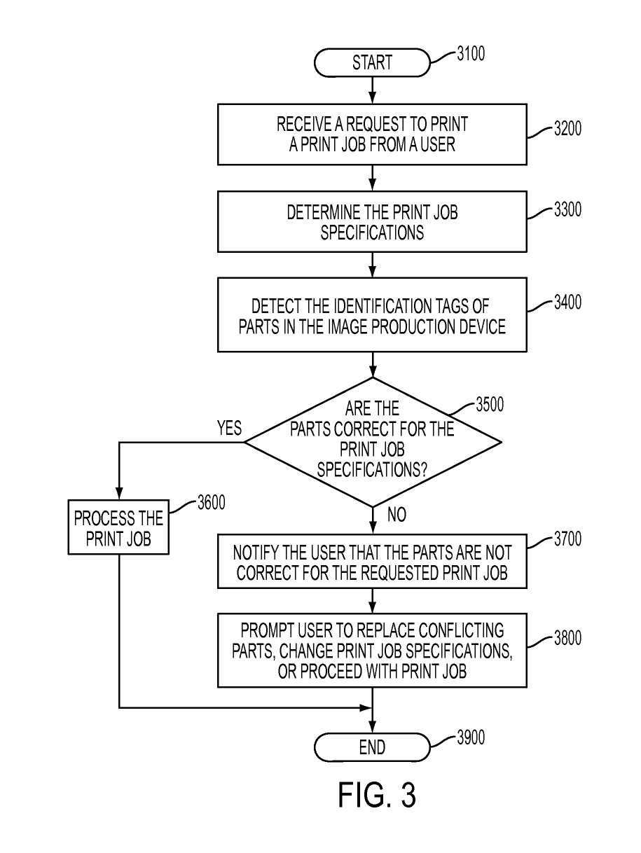

The operation of components of the part identification unit 250 and the part identification process will be discussed below in relation to the flowchart in FIG. 3.

FIG. 3 is a flowchart of a part identification process in accordance with one possible embodiment of the disclosure. The method begins at 3100, and continues to 3200 where the part identification unit 250 may receive a request to print a print job from a user. At step 3300, the part identification unit 250 may determine the print job specifications. The print job specifications may include the size, type, finishing, etc. of the requested print job, for example.

At step 3400, the part detector 270 may detect identification devices of parts that are installed in the image production device and may extract the corresponding part identification information. However, the part identification unit 250 may instead extract the corresponding part identification information from the raw detection data received from the part detector 270. The part identification unit 250 may then receive the extracted part identification information from the identification devices detected by the part detector 270.

At step 3500, the part identification unit 250 may determine if the detected parts that are installed in the image production device 100 are the parts that have been identified for the determined print job specifications based on the extracted part identification information. If the part identification unit 250 determines that the detected parts that are installed in the image production device 100 are the parts that have been identified for the determined print job specifications, at step 3600, the part identification unit 250 may process the print job.

If at step 3500, the part identification unit 250 determines that one or more detected parts that are installed in the image production device 100 are not the parts that have been identified for the determined print job specifications, the process may go to step 3700 where the part identification unit 250 may notify the user using the user interface 150 that the one or more installed parts are not the parts that have been identified for the determined print job specifications.

At step 3800, the part identification unit 250 may prompt the user using the user interface 150 to elect to replace the one or more installed parts, change the print job specifications, or proceed with the print job. If the user elects to proceed with the print job, the part identification unit 250 may send a warning to the user on the user interface 150 of the image production device 100 that warns the user that using the one or more installed parts that have not been identified for print job specifications may cause damage to the one or more installed parts. The process may then go to step 3900 and end.

Note that the part identification unit 250 may receive part identification information from a user for one or more parts and may store the received part identification information in the memory 230. In addition, during operation of the image production device 100, the part identification unit 250 may determine if one or more installed parts have not been identified. In that instance, the part identification unit 250 may prompt the user using the user interface 150 to identify the one or more installed parts, receive the identification information from the user corresponding to the one or more installed parts from the user interface 150, and store the received identification information in the memory 230.

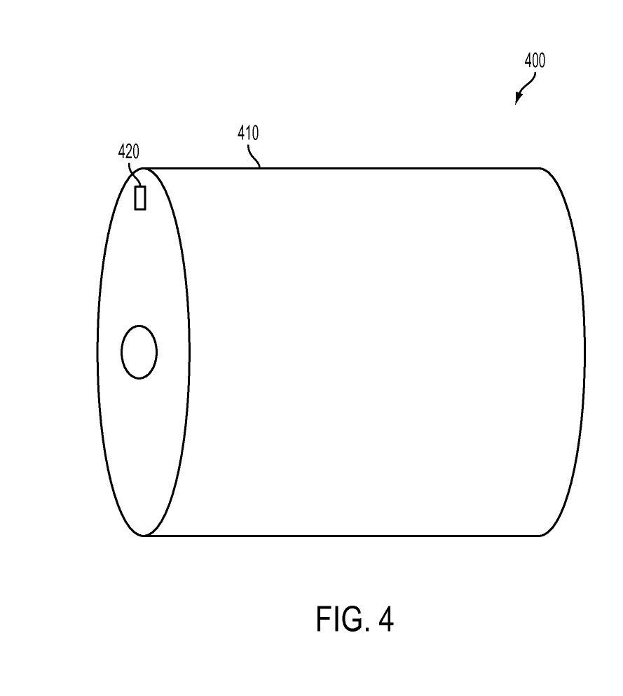

FIG. 4 is a diagram of a fuser roll assembly 400 having an exemplary identification device 420 attached to a fuser roll 410 in accordance with one possible embodiment of the disclosure. The identification device 420 may be attached or embedded in any installed part in the image production device 100, for example.

Note that the fuser roll 410 is shown as one possible installed part in the image production device 100 that may be identified as a print job specific item and may have an identification device 420 attached. However, the disclosed embodiments are not limited to a fuser roll 410 and may include other installed parts having the identification device 420, including a fuser roll module, a pressure roll, or a punch set, for example. Therefore, for example, if a certain type of media was selected to be punched in a certain manner, the installed punch set may not be suitable for the print/punch job and may be damaged if the print job were processed. In this instance, the disclosed process would warn the user that the proper punch set should be used to avoid damage to the installed punch set.

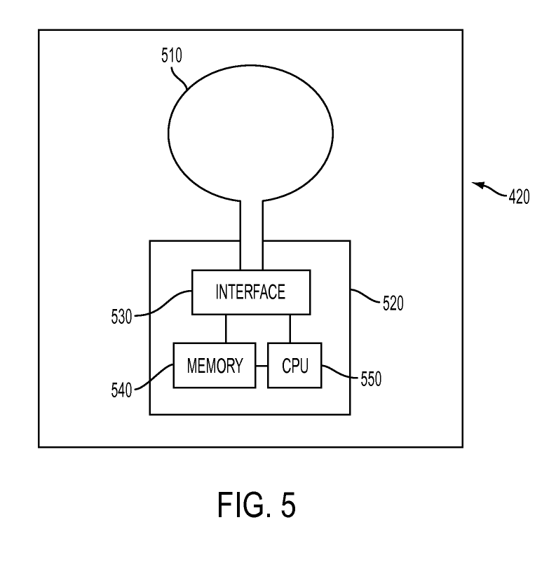

FIG. 5 is an exemplary identification device 420 in accordance with one possible embodiment of the disclosure. The identification device 420 may include electronics 520 that may include memory 540 for storing information, and a communication unit 510 for communicating information to and from the identification device 420. A processor or central processing unit (CPU) 550 may provide computational and other capabilities. Interface unit 530 may connect to the CPU 550, the memory 540, and the communication unit 510. While this particular configuration is shown for the identification device 420, it is merely illustrative as many other configurations are available and known to one of skill in the art and may be used for the purposes of the process described in the disclosed embodiments.

The communication unit 510 may be a wireless or wired communication unit for establishing a wireless communication link with another device, such as the part detector 270. The communication unit 510 may include a radio frequency (RF) antenna for establishing a radio frequency communication link with the part detector 270 or other detection device known to one of skill in the art, for example.

The identification device 420 may be any known identification device including a customer replaceable unit monitor (CRUM) tag, an integrated circuit chip, or a radio frequency identification (RFID) tag, for example. In this manner, the identification device 420 may be an active element powered by a power source, such as a battery (not shown) attached to or embedded in the identification device 420. Alternatively, the identification device 420 may be passive. Such a passive device may be energized by the RF signal it receives from another device, such as the part detector 270 that queries the identification device 420, or the part identification unit 250 that may deliver identification or other information to the identification device 420. Energy from the part detector 270 or the identification device 420 may be sufficient to briefly power the RF antenna and interface electronics to enable the RF antenna to receive and transmit information.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hard wired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein. It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for identifying parts in an image production device, comprising:
receiving a request to print a print job from a user;
determining the print job specifications;
detecting identification devices of parts that are installed in the image production device and extracting the corresponding part identification information;
determining if the detected parts that are installed in the image production device are the parts that have been identified for the determined print job specifications based on the extracted part identification information, wherein if it is determined that the detected parts that are installed in the image production device are the parts that have been identified for the determined print job specifications,
processing the print job,
otherwise, if it is determined that one or more detected parts that are installed in the image production device are not the parts that have been identified for the determined print job specifications,
notifying the user using a user interface that one or more installed parts are not the parts that have been identified for the determined print job specifications;
prompting the user using the user interface to elect to replace the one or more installed parts, change the print job specifications, or proceed with the print job.

2. The method of claim 1, further comprising:
determining if one or more installed parts have not been identified, wherein if it is determined that one or more installed parts have not been identified,
prompting the user to identify the one or more installed parts;
receiving identification information from the user corresponding to the one or more installed parts;
storing the received identification information in a memory.

3. The method of claim 1, wherein if the user elects to proceed with the print job,
sending a warning to the user using the user interface of the image production device that warns the user that using the one or more installed parts that have not been identified for print job specifications may cause damage to the one or more installed parts.

4. The method of claim 1, wherein the identification device is one of a customer replaceable unit monitor tag, an integrated circuit chip, and a radio frequency identification tag.

5. The method of claim 1, further comprising:
receiving part identification information from a user for one or more parts;
storing the received part identification information in a memory.

6. The method of claim 1, wherein the installed part is one of a fuser roll, a fuser roll module, a pressure roll, and a punch set.

7. The method of claim 1, wherein the image production device is one of a copier, a printer, a facsimile device, and a multi-function device.

8. An image production device, comprising:
a user interface for displaying information and receiving selects from a user;
a part detector that detects identification devices of parts that are installed in the image production device and extracts the corresponding part identification information; and
a part identification unit that receives a request to print a print job from a user, determines the print job specifications, receives the extracted part identification information from the identification devices detected by the part detector, determines if the detected parts that are installed in the image production device are the parts that have been identified for the determined print job specifications based on the extracted part identification information, wherein if the part identification unit determines that the detected parts that are installed in the image production device are the parts that have been identified for the determined print job specifications, the part identification unit processes the print job, otherwise, if the part identification unit determines that one or more detected parts that are installed in the image production device are not the parts that have been identified for the determined print job specifications, the part identification unit notifies the user using the user interface that the one or more installed parts are not the parts that have been identified for the determined print job specifications, and prompts the user using the user interface to elect to replace the one or more installed parts, change the print job specifications, or proceed with the print job.

9. The image production device of claim 8, further comprising:
a memory,
wherein the part identification unit determines if one or more installed parts have not been identified, wherein if the part identification unit determines that one or more installed parts have not been identified, the part identification unit prompts the user to identify the one or more installed parts on the using interface, receives identification information from the user corresponding to the one or more installed parts from the user interface, and stores the received identification information in the memory.

10. The image production device of claim 8, wherein if the user elects to proceed with the print job, the part identification unit sends a warning to the user using the user interface that warns the user that using the one or more installed parts that have not been identified for print job specifications may cause damage to the one or more installed parts.

11. The image production device of claim 8, wherein the identification device is one of a customer replaceable unit monitor tag, an integrated circuit chip, and a radio frequency identification tag.

12. The image production device of claim 8, further comprising:
a memory;
wherein the part identification unit receives part identification information from a user for one or more parts and stores the received part identification information in the memory.

13. The image production device of claim 8, wherein the installed part is one of a fuser roll, a fuser roll module, a pressure roll, and a punch set.

14. The image production device of claim 8, wherein the image production device is one of a copier, a printer, a facsimile device, and a multi-function device.

15. A computer-readable medium storing instructions for controlling a computing device for identifying parts in an image production device, the instructions comprising:
receiving a request to print a print job from a user;
determining the print job specifications;
detecting identification devices of parts that are installed in the image production device and extracting the corresponding part identification information;
determining if the detected parts that are installed in the image production device are the parts that have been identified for the determined print job specifications based on the extracted part identification information, wherein if it is determined that the detected parts that are installed in the image production device are the parts that have been identified for the determined print job specifications,
processing the print job,
otherwise, if it is determined that one or more detected parts that are installed in the image production device are not the parts that have been identified for the determined print job specifications,
notifying the user using the user interface that the one or more installed parts are not the parts that have been identified for the determined print job specifications;
prompting the user using a user interface to elect to replace the one or more installed parts, change the print job specifications, or proceed with the print job.

16. The computer-readable medium of claim 15, further comprising:
determining if one or more installed parts have not been identified, wherein if it is determined that one or more installed parts have not been identified,
prompting the user to identify the one or more installed parts;
receiving identification information from the user corresponding to the one or more installed parts;
storing the received identification information in a memory.

17. The computer-readable medium of claim 15, wherein if the user elects to proceed with the print job,
sending a warning to the user using the user interface of the image production device that warns the user that using the one or more installed parts that have not been identified for print job specifications may cause damage to the one or more installed parts.

18. The computer-readable medium of claim 15, wherein the identification device is one of a customer replaceable unit monitor tag, an integrated circuit chip, and a radio frequency identification tag.

19. The computer-readable medium of claim 15, further comprising:
receiving part identification information from a user for one or more parts;
storing the received part identification information.

20. The computer-readable medium of claim 15, wherein the installed part is one of a fuser roll, a fuser roll module, a pressure roll, and a punch set.

21. The computer-readable medium of claim 15, wherein the image production device is one of a copier, a printer, a facsimile device, and a multi-function device.
